(19) United States
(12) Patent Application Publication
(10) Pub. No.: US 2022/0172623 A1
(43) Pub. Date: Jun. 2, 2022

(54) PARKING ASSISTANCE APPARATUS AND PARKING ASSISTANCE SYSTEM

(71) Applicant: DENSO CORPORATION, Kariya-city (JP)

(72) Inventors: Takamasa HIDAKA, Kariya-city (JP); Koudai YAMAURA, Kariya-city (JP)

(21) Appl. No.: 17/673,290

(22) Filed: Feb. 16, 2022

Related U.S. Application Data
(63) Continuation of application No. PCT/JP2020/030701, filed on Aug. 12, 2020.

(30) Foreign Application Priority Data
Aug. 21, 2019 (JP) 2019-151250

(51) Int. Cl. G08G 1/14; B60W 30/06; B60W 40/12; G06V 20/56

(52) U.S. Cl. CPC G08G 1/148; G08G 1/146; B60W 2552/53; B60W 40/12; G06V 20/588; B60W 30/06

(57) ABSTRACT

A parking assistance apparatus is configured to: classify a self-driving vehicle according to a vehicle parameter including a value indicating a size of region required for the self-driving vehicle to travel through, the self-driving vehicle performing a self-driving from an alighting area of a parking lot to a target parking position located in a parking area that includes multiple parking positions; set the target parking position of the self-driving vehicle so that the parking positions including the target parking position are set in collective manner in the parking area according to a classification result of the self-driving vehicle; set a guidance route that guides the self-driving vehicle to the target parking position. As the vehicle parameter, a detection range of a sensor that detects a surrounding of the self-driving vehicle is adopted, and the self-driving vehicle is classified according to the detection range of the sensor.

### CROSS REFERENCE TO RELATED APPLICATIONS

The present application is a continuation application of International Patent Application No. PCT/JP2020/030701 filed on Aug. 12, 2020, which designated the U.S. and claims the benefit of priority from Japanese Patent Application No. 2019-151250 filed on Aug. 21, 2019. The entire disclosures of all of the above applications are incorporated herein by reference.

### TECHNICAL FIELD

The present disclosure relates to a parking assistance apparatus and a parking assistance system each of which assists parking of a vehicle.

### BACKGROUND

There has been known a parking assistance apparatus that sets a guidance route using vehicle parameters, such as a turning radius of a self-driving vehicle, and guides the self-driving vehicle to a target parking position.

### SUMMARY

The present disclosure provides a parking assistance apparatus that is configured to: classify a self-driving vehicle according to a vehicle parameter including a value indicating a size of region required for the self-driving vehicle to travel through, the self-driving vehicle performing a self-driving from an alighting area of a parking lot to a target parking position located in a parking area that includes multiple parking positions; set the target parking position of the self-driving vehicle so that the parking positions including the target parking position are set in collective manner in the parking area according to a classification result of the self-driving vehicle; set a guidance route that guides the self-driving vehicle to the target parking position. As the vehicle parameter, a detection range of a sensor that detects a surrounding of the self-driving vehicle is adopted, and the self-driving vehicle is classified according to the detection range of the sensor.

### BRIEF DESCRIPTION OF DRAWINGS

Objects, features and advantages of the present disclosure will become apparent from the following detailed description made with reference to the accompanying drawings. In the drawings:

FIG. 1 is a plan view schematically showing a parking assistance system;

FIG. 2 is a block diagram showing a configuration of a parking assistance system;

FIG. 3 is a block diagram showing a configuration of a controller of a management device;

FIG. 4 is a block diagram showing a configuration of a controller of a vehicle;

FIG. 5 is a flowchart showing a parking setting process;

FIG. 6 is a diagram showing a classification example of self-driving vehicles;

FIG. 7 is a flowchart showing an automatic parking process;

FIG. 8 is a diagram showing an example of a sequence of parking setting process and automatic parking process;

FIG. 9 is a plan view showing a configuration of a parking lot according to another embodiment;

FIG. 10 is a flowchart showing an automatic parking process;

FIG. 11 is a flowchart showing a parking setting process;

FIG. 12 is a flowchart showing an automatic parking process;

FIG. 13A is a diagram showing a state in which large vehicles are parked in a parking area;

FIG. 13B is a diagram showing a state in which small vehicles are parked in a parking area having the same size as the parking area shown in FIG. 13A;

FIG. 13C is a diagram showing a state in which one small vehicle is parked together with multiple large vehicles shown in FIG. 13A; and

FIG. 13D is a diagram showing a state in which one large vehicle is parked together with multiple small vehicles shown in FIG. 13B.

### DETAILED DESCRIPTION

Before describing embodiments of the present disclosure, detailed examination executed by the inventors of the present application will be described. The above-described parking assistance apparatus can avoid a situation that the self-driving vehicle is guided to a route having a narrow width so that the self-driving vehicle is not able to pass through. However, use efficiency of the parking section cannot be assured with the above-described parking assistance apparatus.

According to an aspect of the present disclosure, a parking assistance apparatus that assists a parking of a vehicle includes: a classification unit classifying a self-driving vehicle according to a vehicle parameter including a value indicating a size of region required for the self-driving vehicle to travel through, the self-driving vehicle performing a self-driving from an alighting area of a parking lot to a target parking position located in a parking area that includes multiple parking positions; a position setting unit setting the target parking position of the self-driving vehicle so that the parking positions including the target parking position are set in collective manner in the parking area according to a classification result of the self-driving vehicle; and a driving setting unit setting a guidance route that guides the self-driving vehicle to the target parking position. The classification unit adopts, as the vehicle parameter, a detection range of a sensor that detects a surrounding of the self-driving vehicle, and classifies the self-driving vehicle according to the detection range of the sensor.

With the above-described parking assistance apparatus, the self-driving vehicle is classified according to the vehicle parameter. Thus, it is possible to collectively park multiple self-driving vehicles that require parking sections of similar sizes together in a parking area. Thus, the parking space in the parking lot can be used in efficient manner.

The following will describe embodiments of the present disclosure with reference to the drawings.

### 1. Embodiment

1-1. Configuration of Parking Assistance System

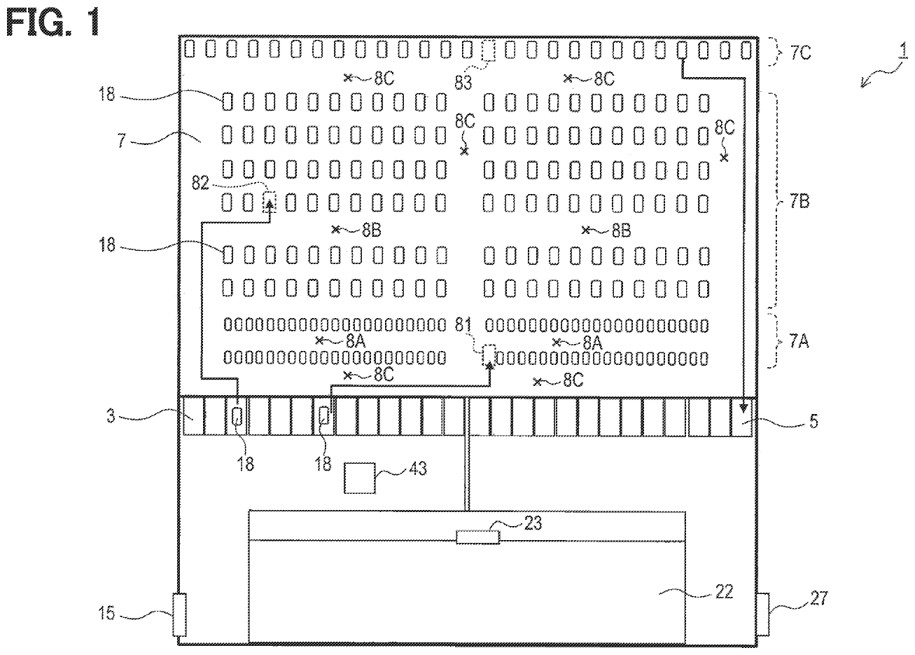

The following will describe a configuration of a parking assistance system 1 with reference to FIG. 1 to FIG. 3. As shown in FIG. 1, the parking assistance system 1 includes an entrance room 3 set in an alighting area where the user alights from the vehicle, and an exit room 5 set in a boarding area where the user boards on the vehicle, and a parking area 7. In the following description, an area including the entrance room 3, the exit room 5, and the parking area 7 is referred to as a parking lot.

In the parking lot, multiple entrance rooms 3 and multiple exit rooms 5 are prepared. The entrance room 3 is connected to an outside area of the parking assistance system 1 through an entrance 15. The self-driving vehicle 18 enters the entrance room 3 of the parking lot through the entrance 15. The self-driving vehicle 18 has an automatic valet parking function.

It should be noted that the self-driving vehicle 18 only needs to be able to carry out the automatic valet parking function in the parking lot, and does not need to have a self-driving function outside the parking lot. Further, the automatic valet parking function includes a function of traveling from the entrance room 3 to the target parking position of the parking area 7 and parking by self-driving. The automatic valet parking function also includes a function of traveling from the parking position of the parking area 7 to the exit room 5.

The automatic valet parking function includes repeatedly acquiring position information of the self-driving vehicle 18, transmitting acquired position information to a management device 39, receiving a guidance route from the management device 39, and controlling the self-driving vehicle 18 to travel along the received guidance route. The position information of the self-driving vehicle 18 indicates an estimation result of the current position of the self-driving vehicle 18, and includes, for example, coordinates of the current position within an area of the parking lot.

The entrance room 3 and the exit room 5 may be adjacent to an entrance 23 of a facility 22, such as a store. The occupant of the self-driving vehicle 18, who has entered the entrance room 3, gets off the self-driving vehicle 18. Then, the occupant can walk to the entrance 23.

The parking area 7 is an area where multiple vehicles 18 can be parked. The parking area 7 includes multiple parking zones. Each parking zone includes multiple parking sections. A direction in which multiple parking sections are aligned in the entrance room 3 or in the exit room 5 is referred to as a row direction.

Along the row direction, two lines of parking sections closest to the entrance room 3 and the exit room 5 is defined as a close area 7A. Along the row direction, one line of parking sections farthest from the entrance room 3 and the exit room 5 is defined as a far area 7C. In the parking area 7, an area excluding the close area 7A and the far area 7C is defined as a medium area 7B.

In FIG. 1, although the parking lot is shown as a flat parking lot, the parking lot may be a multi-storey parking lot. If the parking lot is a multi-storey parking lot, the two lines of sections closest to the entrance room 3 and the exit room 5 may be set as the close area 7A. The one line of sections farthest from the entrance room 3 and the exit room 5 may be set as the far area 7C. In the parking area 7, an area excluding the close area 7A and the far area 7C may be set as the medium area 7B. Here, the two lines of sections in the close area indicates that a moving distance of the vehicle or a distance along the guidance route is short. The one line of sections in the far area indicates that the moving distance of the vehicle or the distance along the guidance route is long.

Each section of the entrance rooms 3, the exit rooms 5, and the parking area 7 is a space where one self-driving vehicle 18 can be parked. The self-driving vehicle 18 can travel from the entrance room 3 to the parking area 7. The self-driving vehicle 18 can travel from the parking area 7 to the exit room 5.

The close area 7A is divided into multiple sections so that only vehicles with small sizes can be parked. The sections may be marked by, for example, by white lines. The small vehicle that can be parked in the close area 7A corresponds to, for example, a light vehicle and a mini vehicle defined under the Road Traffic Act.

The medium area 7B and the far area 7C are divided into multiple sections so that vehicles having sizes larger than the small vehicles can be parked. The vehicles that can be parked in the medium area 7B and the far area 7C may include a small size passenger car, an ordinary size passenger car, or the like.

In the present embodiment, the multiple sections in the parking area 7 are arranged so that vehicles of the same size are lined up in the row direction of the parking area 7, that is, along the arrangement of the vehicles in the vehicle width direction. For example, in a case where a shape of the parking area 7 is rectangular as shown in FIG. 1, in the medium area 7B, each line along the row direction may include 22 sections for parking 22 vehicles of large sizes. In the close area 7A, each line along the row direction may include 42 sections for parking 42 vehicles of small sizes.

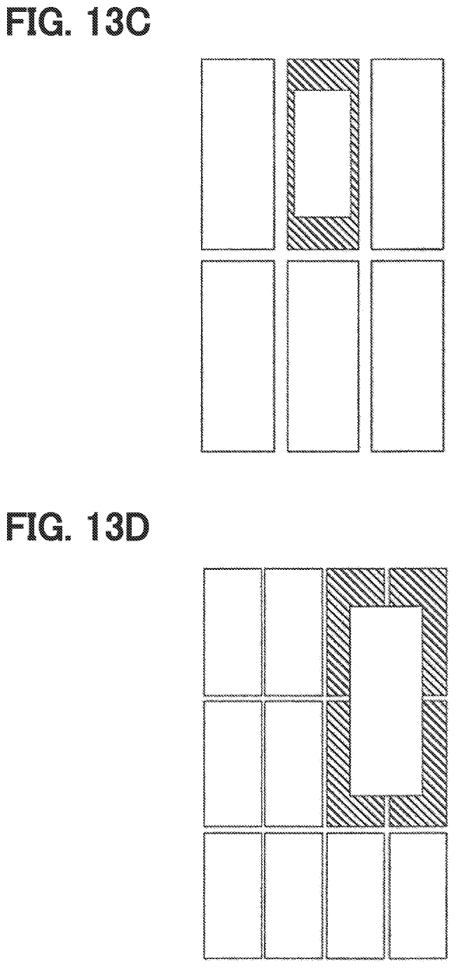

The following will describe collective parking of the self-driving vehicles 18 with reference to FIG. 13A to FIG. 13D. The entire sizes of the parking sections shown in FIG. 13 to FIG. 13D are the same. FIG. 13A shows multiple vehicles of the same sizes that are parked in the row direction and in a column direction within the parking area. FIG. 13A shows six large vehicles L in parked states. FIG. 13B shows multiple vehicles of the same sizes that are parked in the row direction and in the column direction within the parking area. FIG. 13B shows twelve small vehicles S in parked states.

FIG. 13C shows a small vehicle S that is parked in the section prepared for the large vehicle L shown in FIG. 13A. FIG. 13D shows one large vehicle L that is parked in four sections prepared for four small vehicles S shown in FIG. 13B. In FIG. 13C and FIG. 13D, hatching areas of the parking sections are unavailable for parking. By setting the sections so that vehicles of the same sizes are parked side by side in a lateral direction or in a longitudinal direction of the vehicle, it is possible to suppress the generation of unavailable areas that are unavailable for parking. Thus, more vehicles can be parked in the parking area and the parking area can be used with high efficiency.

In FIG. 13A to FIG. 13D, multiple vehicles of the same sizes are parked side by side in both of the lateral direction and the longitudinal direction of the vehicle. Alternatively, the vehicles of the same sizes may be parked either in the lateral direction or in the longitudinal direction of the vehicle. In this case, it is also possible to suppress the generation of unavailable areas that are unavailable for parking compared with a case where the vehicles of different sizes are parked in mixed manner.

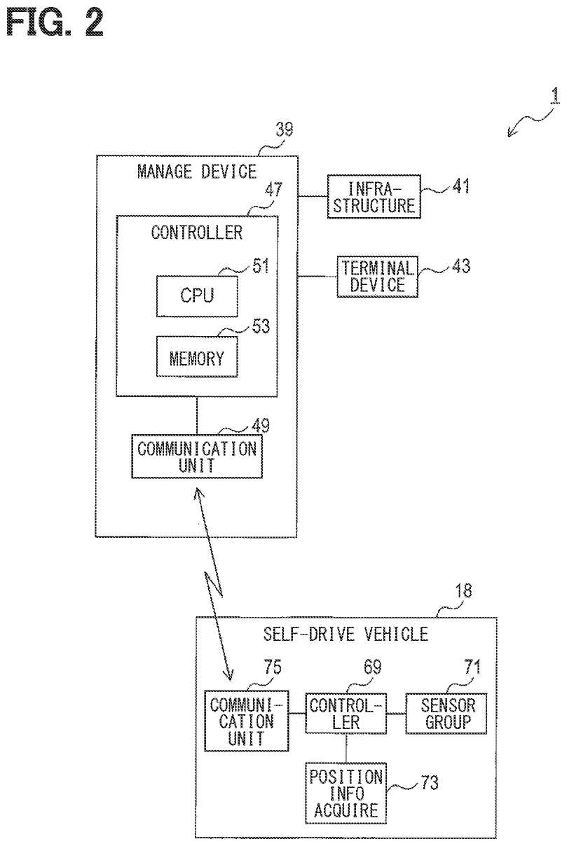

As shown in FIG. 2, the parking assistance system 1 includes the management device 39, an infrastructure 41, and a terminal device 43. The management device 39 corresponds to a parking assistance apparatus in the present disclosure.

The management device 39 includes a controller 47 and a communication unit 49. The controller 47 includes a microcomputer having a CPU 51 and a semiconductor memory (hereinafter referred to as a memory 53) such as a RAM or a ROM, for example.

The CPU 51 executes a program stored in a non-transitory tangible storage medium to perform functions to be provided by the controller 47. In this example, the memory 53 corresponds to a non-transitory tangible storage medium storing the program. When the program is executed, a method corresponding to the program is executed. The controller 47 may include one or more microcomputers.

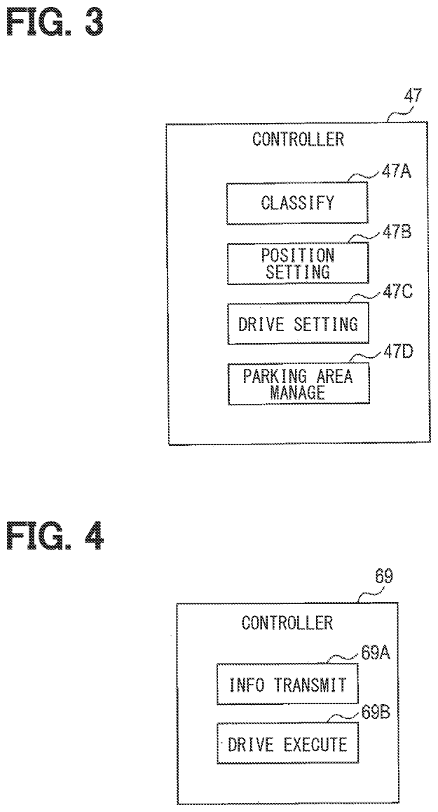

The controller 47 is configured to transmit, to the self-driving vehicle 18, the guidance route to the parking position and a parking start instruction. For example, as shown in FIG. 3, the controller 47 may include a classification unit 47A, a position setting unit 47B, a driving setting unit 47C, and a parking area management unit 47D. The following will describe an operation executed by each unit 47A to 47D included in the controller 47.

The memory 53 stores map information of the inside area of the parking lot. The map information includes information indicating a state of each parking section included in the parking area 7. The state of parking section may be an available state where the parking section is vacant (hereinafter referred to as a vacant state) and an unavailable state where the parking section is occupied by the vehicle 18 (hereinafter referred to as an occupied state). In the example shown in FIG. 1, the sections 81 to 83 are in the vacant state, and the remaining sections are in the occupied states. The section 81 is located in the close area 7A, the section 82 is located in the medium area 7B, and the section 83 is located in the far area 7C. The communication unit 49 is configured to communicate with the self-driving vehicle 18, and may be provided by a transceiver circuit.

The memory 53 stores information about the close area 7A, the medium area 7B, and the far area 7C. The parking area management unit 47D may set multiple close areas 7A, multiple medium areas 7B, and multiple far areas 7C in the parking area 7, and stores information about the parking area 7 in the memory 53. The position setting unit 47B sets the parking position by referring to the information of the parking area 7 stored in the memory 53.

The infrastructure 41 acquires information representing the state inside the parking assistance system 1 (hereinafter referred to as parking lot information) and provides the parking lot information to the management device 39. The infrastructure 41 may include a camera or a LiDAR that photograph the inside area of the parking assistance system 1.

The parking lot information includes, for example, information indicating a position of an obstacle, information indicating a state of a parking space of the parking area 7, and position information of the self-driving vehicle 18 existing in the parking assistance system 1.

As shown in FIG. 1, the terminal device 43 is installed close to the entrance room 3. The terminal device 43 accepts an input operation made by an occupant. The terminal device 43 outputs a signal indicating the input operation to the management device 39.

The terminal device 43 outputs a parking request signal, for example, in response to the input operation. The parking request signal is a signal that requests a transport of the vehicle 18 in the entrance room 3 to the parking area 7 and a parking of the vehicle 18 in the parking space. The terminal device 43 may output, to the management device 39, identification information of the self-driving vehicle 18 together with the signal output in response to the input operation.

The terminal device 43 outputs, for example, an exit request signal or the like in response to the input operation. The exit request signal is a signal that requests a transport of the vehicle 18 parked in the parking area 7 to the exit room 5. The terminal device 43 may output the identification information of the self-driving vehicle 18 in response to the input operation. The identification information may include number plate information for identifying the self-driving vehicle 18.

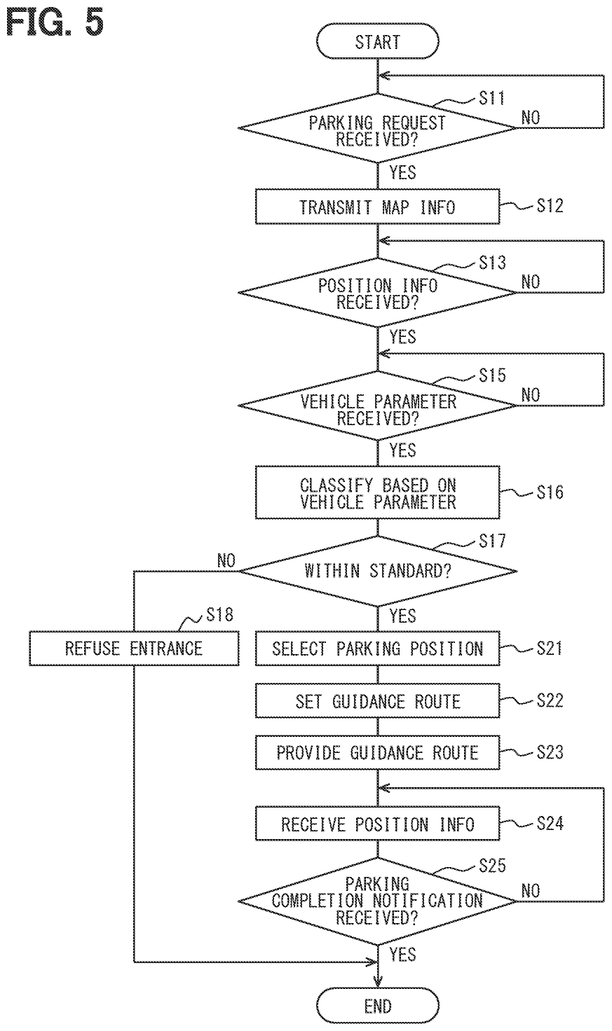

As described above, the self-driving vehicle 18 has an automatic valet parking function. As shown in FIG. 2, the self-driving vehicle 18 includes a controller 69, a sensor group 71, a position information acquisition unit 73, and a communication unit 75. As shown in FIG. 4, the controller 69 includes an information transmission unit 69A and a driving execution unit 69B. The following will describe an operation executed by each unit 69A, 69B included in the controller 69.

The controller 69 controls the operation of the self-driving vehicle 18. The function of the self-driving is performed by the controller 69. The self-driving vehicle 18 acquires, from the management device 39, the map information of the parking lot and the guidance route. When performing the self-driving, the self-driving vehicle 18 uses the acquired map information and the guidance route.

The sensor group 71 is configured to acquire peripheral information indicating a situation around the self-driving vehicle 18. The peripheral information includes, for example, a position of an obstacle existing around the self-driving vehicle 18, marking lines on the ground surface, a position of a marker, or the like. The marker will be described later. The sensor group 71 may include a camera, a LiDAR, and the like. The self-driving vehicle 18 uses the peripheral information when performing the self-driving.

The position information acquisition unit 73 acquires the position information of the self-driving vehicle 18. The position information acquisition unit 73 is, for example, a position estimation system using the LiDAR and a map. The self-driving vehicle 18 uses the position information when performing self-driving. The communication unit 75 is configured to communicate with the management device 39.

(1-2. Process)

(1-2-1. Process Executed by Management Device 39)

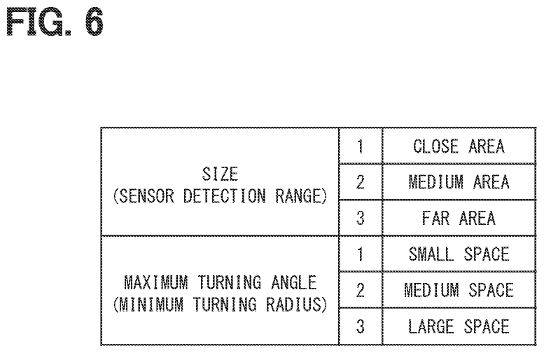

The following will describe a parking setting process executed by the management device 39 with reference to FIG. 5. The parking setting process may be configured to start in response to the power of the management device 39 being turned on. After start of the parking setting process, the process is repeatedly executed.

In S11 of the parking setting process shown in FIG. 5, the driving setting unit 47C of the management device 39 determines whether a parking request signal is received.

When a user inputs a parking request by operating the terminal device 43, the terminal device 43 transmits the parking request signal corresponding to the user's input operation to the management device 39. At this time, the user inputs vehicle information such as number plate information for identifying the vehicle, user information such as a user ID and a password for identifying the user, and other necessary information to the terminal device 43.

When the terminal device 43 is operated by the user, the vehicle information, the user information, and the like are transmitted to the management device 39. After inputting the parking request, the user can leave the parking lot and head for a destination. Subsequently, the driving setting unit 47C transmits the map information of the parking lot to the self-driving vehicle 18 in S12.

The self-driving vehicle 18 that has received the map information is required to return the position information. The driving setting unit 47C determines, in S13, whether the position information has been received. When determining the position information is not received in S13, the process repeats S13.

When the position information is received in S13, the process proceeds to S15, and the classification unit 47A of the management device 39 determines whether the vehicle parameter is received from the self-driving vehicle 18. The vehicle parameter may include a value indicating a size of space required for the vehicle to travel through. The vehicle parameter may include a size of the self-driving vehicle 18, a size of the maximum turning angle of the wheels of self-driving vehicle 18, a size of the minimum turning circle, and a detection range of the sensor that detects the surrounding of the self-driving vehicle 18.

The entrance room 3 may include a camera, and the management device 39 may calculate, as the vehicle parameter, the size of self-driving vehicle 18 based on the vehicle image captured by the camera. Alternatively, the vehicle parameter may include one or multiple information among the size of self-driving vehicle 18, the size of maximum turning angle of the wheels of self-driving vehicle 18, the size of minimum turning circle, and the detection range of the sensor that detects the surrounding of the self-driving vehicle 18.

The size of self-driving vehicle 18 may include at least one of the width, length, or height of the self-driving vehicle 18. In the present embodiment, the width and the length of self-driving vehicle 18 are adopted as the size of self-diving vehicle 18.

The classification unit 47A repeats S15 when no vehicle parameter is received in S15. When the vehicle parameter is received in S15, the process proceeds to S16, and the self-driving vehicle 18 is classified according to the vehicle parameter.

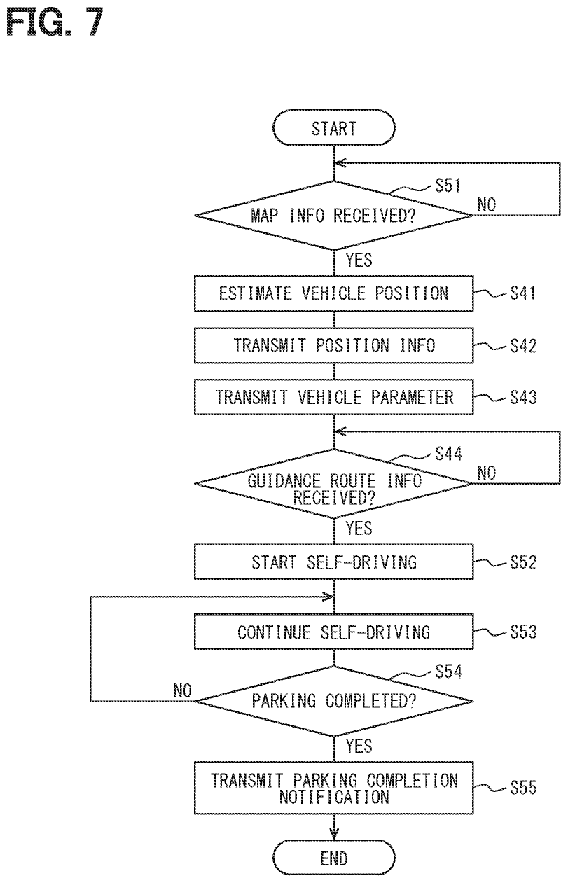

As shown in FIG. 6, the classification unit 47A classifies the self-driving vehicle 18 into three size levels including first level indicated by “1”, second level indicated by “2”, and third level indicated by “3” based on the size of self-driving vehicle 18. For example, when the self-driving vehicle 18 is a light vehicle or a mini car, the classification unit 47A classifies the self-driving vehicle 18 into the first level. When a total length of the self-driving vehicle 18 is less than 4.5 meters, the classification unit 47A classifies the self-driving vehicle 18 into the second level. When a total length of the self-driving vehicle 18 is 4.5 meters or more, the classification unit 47A classifies the self-driving vehicle 18 into the third level. With an increase of the size of section required for parking, the classification level is increased.

The classification unit 47A also classifies the self-driving vehicle 18 into three maximum turning angle levels including first level indicated by “1”, second level indicated by “2”, and third level indicated by “3” based on the magnitude of maximum turning angle of the wheels of self-driving vehicle 18. For example, when the maximum turning angle is equal to or greater than a first threshold, the classification unit 47A classifies the self-driving vehicle 18 into the first level. When the maximum turning angle is equal to or greater than a second threshold and less than the first threshold, the classification unit 47A classifies the self-driving vehicle 18 into the second level. When the maximum turning angle is less than the second threshold, the classification unit 47A classifies the self-driving vehicle 18 into the third level. With an increase of the size of space required for turning, the classification level is increased.

Instead of the size of self-driving vehicle 18, the classification unit 47A may classify the self-driving vehicles based on the detection range of the sensor that detects the surrounding of self-driving vehicle 18. In another example, the classification unit 47A may classify the self-driving vehicles based on both of the size of self-driving vehicle 18 and the detection range of the sensor that detects the surrounding of self-driving vehicle 18. The detection range of the sensor may be obtained by, for example, adding a detection distance of the sensor to the size of self-driving vehicle 18. The classification unit 47A may classify the self-driving vehicles 18 based on the size of minimum turning circle instead of the maximum turning angle or in combination with the maximum turning angle.

The classification unit 47A proceeds to S17 and determines whether the self-driving vehicle 18 can be parked in the parking area based on the vehicle parameter transmitted from the self-driving vehicle 18. Specifically, the classification unit determines, based on the parameter of self-driving vehicle 18, whether the self-driving vehicle 18 is within a preset standard. For example, when the maximum turning angle is the third level or any one of the width, length, or height of the vehicle size is equal to or higher than a corresponding upper limit set in advance, the classification unit 47A determines that the self-driving vehicle 18 is out of the standard and cannot be parked in the parking area. When determining that the self-driving vehicle cannot be parked in the parking area, the process proceeds to S18. In S18, the driving setting unit 47C refuses the self-driving vehicle 18 to enter the parking area, and ends the parking setting process. At this time, the driving setting unit 47C notifies the self-driving vehicle 18 of the entrance refusal, which indicates the entrance refusal to the parking area.

When determining that the self-driving vehicle can be parked, the process proceeds to S21, and the position setting unit 47B of the management device 39 selects a parking position.

In the parking area 7, a vacant parking section may be selected as the parking position. The position setting unit 47B determines the state of each section as follows. When the self-driving vehicle 18 starts parking in a certain parking section, the self-driving vehicle 18 sends the identification information of the parking section and parking start information to the management device 39. Further, when the self-driving vehicle 18 leaves the parking section in which the vehicle has been parked, the self-driving vehicle 18 sends the identification information of the parking section and parking end information to the management device 39.

The position setting unit 47B determines the state of each parking section based on the history of information sent from the self-driving vehicle 18. Further, the position setting unit 47B may determine the state of each parking section based on the information supplied by the infrastructure 41.

In the setting of the parking position by the position setting unit 47B, the size level classified based on the size of the self-driving vehicle 18 is used. As shown in FIG. 6, when the size level of the self-driving vehicle 18 is classified as the first level, the position setting unit 47B sets the parking position of the self-driving vehicle 18 in an empty section of the close area 7A. When the size of the self-driving vehicle 18 is classified as the second level, the position setting unit 47B sets the parking position of the self-driving vehicle 18 in an empty section of the medium area 7B. When the size of the self-driving vehicle 18 is classified as the third level, the position setting unit 47B sets the parking position of the self-driving vehicle 18 in an empty section of the far area 7B.

As described above, the position setting unit 47B sets the parking positions in collective manner for the self-driving vehicles 18 corresponding to the classification result of each self-driving vehicle 18. The position setting unit 47B sets the parking position of the self-driving vehicle 18 classified into a relatively small size in the close area 7A which is closer to the boarding position or the alighting position where the occupant gets on or gets off the self-driving vehicle 18 compared with the medium area 7B and the far area 7C having the parking sections prepared for the self-driving vehicles 18 classified into relatively large sizes. That is, the position setting unit 47B sets the parking position of the self-driving vehicle 18 classified into a size smaller than a predetermined threshold closer to the parking position of the self-driving vehicle 18 classified into a size equal to or larger than the predetermined threshold with respect to the boarding position or the alighting position where the occupant gets on or gets off the self-driving vehicle 18.

The position setting unit 47B may set the parking position of the self-driving vehicle 18 so that the self-driving vehicles 18 classified in the same size are lined up in the vehicle width direction when the self-driving vehicles 18 are parked in the parking area 7.

If there is no empty section in the area 7A, 7B, or 7C corresponding to the classification result, the parking position may be set in an empty section of another area. For example, in S21, when determining that vacant parking position is not available in the parking area corresponding to the classification result of the self-driving vehicle 18, the parking area management unit 47D may change the parking area corresponding to the classification result of the self-driving vehicle 18 to an adjacent area, and sets the adjacent area as the parking area corresponding to the classification result of the self-driving vehicle 18.

Specifically, when the close area 7A corresponding to the classification result is full, one line of the medium area 7B closest to the close area 7A may be used as the close area 7A. The parking area management unit 47D may set the parking area of the parking lot corresponding to the classification result of the self-driving vehicle 18 at any time, such as immediately after the start of the parking setting process or before the start of the parking setting process.

In S22, the driving setting unit 47C sets a guidance route from the current position of the self-driving vehicle 18 to the parking position selected in S21 by using the map information of the parking lot.

As shown in FIG. 1, each path in the parking area 7 is associated with the classification of the self-driving vehicle 18 that can pass the path according to the width of the path. The path is an area not set as the sections of the parking area 7. The path 8A shown in FIG. 1 is the narrowest path, and only the vehicles classified as the first maximum turning angle level can pass through the path 8A. The path 8B shown in FIG. 1 is the path wider than the path 8A, and the vehicles classified as the first and second maximum turning angle levels can pass through the path 8B. The path 8C is the widest path, and all of the vehicles allowed to enter the parking area can pass through the path 8C.

The driving setting unit 47C sets the guidance route by using the path, through which the self-driving vehicle 18 can pass, according to the classification under the maximum turning angle.

In S23, the driving setting unit 47C transmits information representing the guidance route set in S22 (hereinafter referred to as guidance route information) using the communication unit 49. The guidance route information may also function as an instruction to start parking of the self-driving vehicle 18. As being described later, the self-driving vehicle 18 receives the guidance route information, and starts self-driving along the set guidance route.

The driving setting unit 47C receives in S24 the position information of the self-driving vehicle 18. Then, In S25, the driving setting unit 47C determines whether the communication unit 49 has received the parking completion notification. The parking completion notification is a notification transmitted by the self-driving vehicle 18 when the self-driving vehicle 18 completes parking at the parking position, which is the end point of the guidance route. In response to reception of the parking completion notification, the driving setting unit 47C ends the process. In response to no reception of the parking completion notification, the process returns to S24.

(1-2-2. Automatic Parking Process Executed by Self-Driving Vehicle 18)

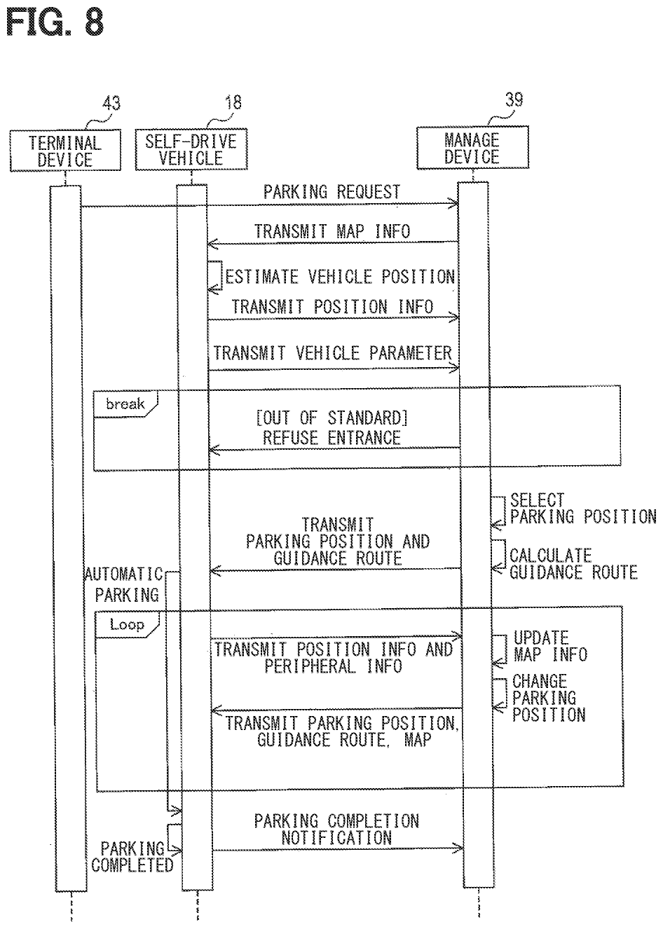

The following will describe an automatic parking process executed by the self-driving vehicle 18 with reference to FIG. 7. The automatic parking process is a process in which the self-driving vehicle 18 automatically moves from the entrance room 3 to the parking position according to the parking setting process executed by the management device 39.

The driving execution unit 69B of controller 69 determines, in S51, whether the communication unit 75 has received the map information of the parking lot. When the map information is not received, the process repeats S51.

When the map information is received, the process proceeds to S41. The driving execution unit 69B estimates, in S41, the current position of the self-driving vehicle 18. Then, in S42, the controller transmits the estimation result of the current position to the management device 39 as the position information of the self-driving vehicle 18.

The information transmission unit 69A of the controller 69 transmits vehicle parameters in S43. The vehicle parameters are the same as the information received in the management device 39.

The driving execution unit 69B determines, in S44, whether the guidance route information is received. Herein, the guidance route information is transmitted by the management device 39. When determining that the guidance route information is not received in S44, the driving execution unit 69B repeats S44. When the guidance route information is received in S44, the driving execution unit 69B starts the self-driving of the self-driving vehicle 18 in S52. When performing the self-driving, the driving execution unit 69B drives the self-driving vehicle 18 according to the guidance route indicated by the guidance route information.

The driving execution unit 69B continues the self-driving of the self-driving vehicle 18 in S53. At this time, the driving execution unit 69B repeatedly transmits the position information of the self-driving vehicle 18 until the parking of the self-driving vehicle is determined to be completed in S54. The management device 39 receives the position information transmitted from the self-driving vehicle.

The driving execution unit 69B determines, in S54, whether the parking is completed. The completion of parking is determined when the self-driving vehicle 18 arrives at and being parked in the parking position set in the management device 39. When the parking is not yet completed, the process return to S53.

In S54, when determining that the parking is completed, the process proceeds to S55, and the driving execution unit 69B transmits the parking completion notification using the communication unit 75. Then, the process is ended. The management device 39 receives the parking completion notification transmitted from the self-driving vehicle 18.

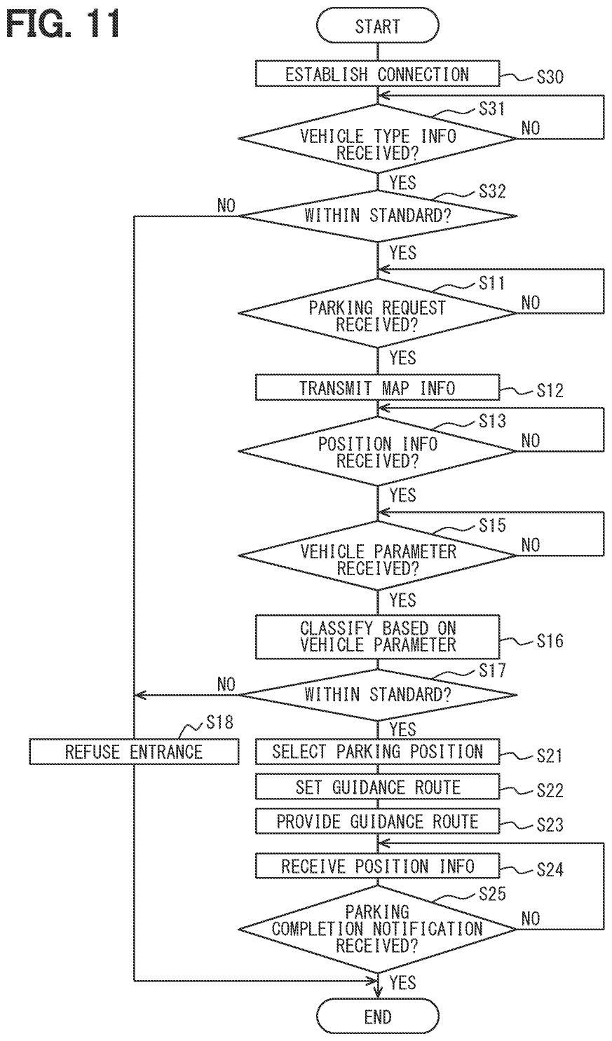

FIG. 10 is a flowchart illustrating an automatic parking process executed by the self-driving vehicle 18 according to another embodiment. The process executed in S51, S52, S53, S54, and S55 of FIG. 10 are the same as those shown in FIG. 7. In the automatic parking process shown in FIG. 10, when the guidance route information is not received in S44, the driving execution unit 69B determines, in S56, whether the entrance refusal is notified from the management device 39 to the self-driving vehicle 18. As described above, the entrance refusal is a notification indicating entrance to the parking lot is refused. When determining that the entrance refusal is not received in S56, the driving executing unit 69B returns to S44. When determining that the entrance refusal is received in S56, the automatic parking process is ended. Alternatively, the user may be notified via the terminal device 43 that the entrance to the parking lot is refused. With this configuration, the user can be notified of that the automatic parking of the self-driving vehicle 18 is not available.

(1-2-3. Example of Sequence)

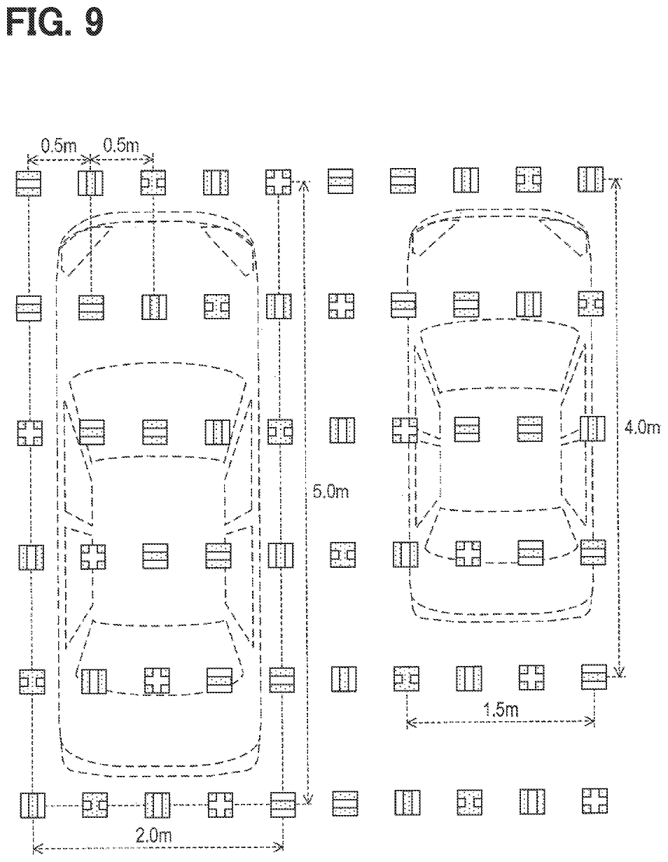

FIG. 8 shows an example of the sequence executed by the terminal device 43, the management device 39, and the self-driving vehicle 18. In this sequence, when the user inputs a parking start instruction in the terminal device 43, the management device 39 transmits the map information to the self-driving vehicle 18, and the self-driving vehicle 18 receives the map information from the management device 39. In response to the reception of the map information, the self-driving vehicle 18 transmits the vehicle parameters to the management device 39, and the management device 39 sets the parking position and the guidance route according to the vehicle parameter of the self-driving vehicle 18.

(1-3. Effects)

The above-described embodiments provides the following effects.

(1a) One aspect of the present disclosure provides the management device 39 configured to assist parking of the self-driving vehicle in the parking lot. The management device 39 includes the classification unit 47A, the position setting unit 47B, and the driving setting unit 47C. The self-driving vehicle 18 is able to perform self-driving from the alighting area in the parking lot to the parking position set by the management device 39 in the parking area including multiple parking sections.

The classification unit 47A classifies the self-driving vehicle 18 according to the vehicle parameter representing the value related to the size of space required for the vehicle to travel through. As described above, the position setting unit 47B sets the parking positions in collective manner for the self-driving vehicles 18 corresponding to the classification result of each self-driving vehicle 18. The driving setting unit 47C sets the guidance route for guiding the self-driving vehicle 18 to the set parking position.

With the parking assistance system 1, the self-driving vehicles 18 are classified according to the vehicle parameters. Thus, it is possible to collectively park multiple self-driving vehicles 18 that require parking sections of similar sizes close to one another. Thus, the parking sections can be used in efficient manner. For example, the number of vehicles that can be parked in the parking lot can be increased.

(1b) In one aspect of the present disclosure, the classification unit 47A classifies the self-driving vehicle 18 according to the size of self-driving vehicle 18 as the vehicle parameter.

According to such parking assistance system 1, the end positions of multiple vehicles can be aligned when the self-driving vehicles 18 are parked in the corresponding parking positions, thereby improving the utilization efficiency of the parking area.

(1c-1) In one aspect of the present disclosure, the position setting unit 47B sets the parking position of the self-driving vehicle 18 classified into a relatively small size closer to the boarding position or the alighting position where the occupant gets on or gets off the self-driving vehicle 18 compared with the parking position of self-driving vehicles 18 classified into a relatively large size.

(1c-2) In one aspect of the present disclosure, the classification unit 47A classifies the self-driving vehicle 18 according to the size of self-driving vehicle 18 as the vehicle parameter. The position setting unit 47B sets the parking position of the self-driving vehicle 18 classified into a size smaller than a predetermined threshold closer to the parking position of the self-driving vehicle 18 classified into a size equal to or larger than the predetermined threshold with respect to the boarding position or the alighting position where the occupant gets on or gets off the self-driving vehicle 18.

(1c-3) With the parking assistance system described in (1c-1) and (1c-2), the parking position of self-driving vehicle 18 requiring a small-size parking section is set closer to the boarding position or alighting position where the occupant gets on or gets off the vehicle. Thus, in an area close to the boarding position or the alighting position, the number of parking sections prepared for the small-size self-driving vehicles 18 can be set to be greater compared with a case where large-size vehicles are parked in the close area. Therefore, a total travel distance of the multiple self-driving vehicles 18 within the parking lot can be reduced with a lower total fuel consumption.

(1d) In one aspect of the present disclosure, the classification unit 47A classifies the self-driving vehicle 18 according to the maximum turning angle of the wheels of self-driving vehicle 18 or according to the minimum turning circle as the vehicle parameter. According to such parking assistance system 1, the self-driving vehicle 18 is classified according to the maximum turning angle of the wheels of self-driving vehicle 18 or the minimum turning circle. Thus, the width of the path can be set to a smaller width as necessary.

(1e) In one aspect of the present disclosure, the classification unit 47A classifies the self-driving vehicle 18 according to the detection range of the sensor that detects surrounding of the self-driving vehicle 18 as the vehicle parameter.

According to such parking assistance system 1, the self-driving vehicle 18 is classified based on the detection range of the sensor that detects the surrounding of the vehicle. Thus, a distance margin between the self-driving vehicle 18 and a surrounding object, such as a wall surface, another parked vehicle can be minimized.

(1f) In one aspect of the present disclosure, the classification unit 47A determines, based on the parameter of self-driving vehicle 18, whether the self-driving vehicle 18 is within the preset standard. Further, the driving setting unit 47C notifies the self-driving vehicle 18 of the entrance refusal when the self-driving vehicle 18 is out of the preset standard.

According to this configuration, when the self-driving vehicle 18 is not within the preset standard, the self-driving vehicle 18 can be notified of the entrance refusal.

(1g) In one aspect of the present disclosure, the management device 39 includes the parking area management unit 47D. The parking area management unit 47D sets the parking area corresponding to the classification result of self-driving vehicle 18. Then, the position setting unit 47B sets the parking position of the self-driving vehicle 18 in the determined parking area corresponding to the classification result of self-driving vehicle 18.

According to such parking assistance system 1, since the parking area management unit 47D sets the parking area of the parking lot corresponding to the classification result of the self-driving vehicle 18, the position setting unit 47B is able to set the parking position in the parking area set by the parking area management unit.

(1h) In one aspect of the present disclosure, when determining that vacant parking position is not available in the parking area corresponding to the classification result of the self-driving vehicle 18, the parking area management unit 47D changes the parking area corresponding to the classification result of the self-driving vehicle 18 to an adjacent area, and sets the adjacent area as the parking area corresponding to the classification result of the self-driving vehicle 18.

According to this configuration, in a case where there is no vacant parking position in the parking area corresponding to the classification result of the self-driving vehicle 18 and there exists a vacant parking position in the adjacent area that is adjacent to the parking area corresponding to the classification result of the self-driving vehicle, the self-driving vehicle 18 can be parking in the adjacent area. Specifically, when the close area 7A corresponding to the classification result is full, one line of the medium area 7B closest to the close area 7A may be used as the close area 7A.

(1i) In one aspect of the present disclosure, the classification unit 47A classifies the self-driving vehicle 18 according to the size of self-driving vehicle 18 as the vehicle parameter. The position setting unit 47B sets the parking position of the self-driving vehicle 18 so that the self-driving vehicles 18 classified in the same size are lined up in the vehicle width direction when the self-driving vehicles 18 are parked in the parking area 7.

According to this configuration, multiple self-driving vehicles 18 classified into the same size can be arranged side by side in the width direction of the vehicle. Thus, unavailable dead space in the parking area can be reduced, and the utilization efficiency of the parking area can be improved.

### 2. Other Embodiments

Although the embodiments of the present disclosure have been described above, the present disclosure is not limited to the above-described embodiments, and various modifications can be made.

(2a) In the above embodiments, the marking lines of parking sections in the parking area 7 are described as white lines as an example. The present disclosure is not limited to this configuration. For example, the road surface of the parking lot may be provided with various markings, can be recognized by the self-driving vehicle 18. The various markings may be prepared in advance for defining the parking sections, and the parking sections may be indicated by various kinds of markings.

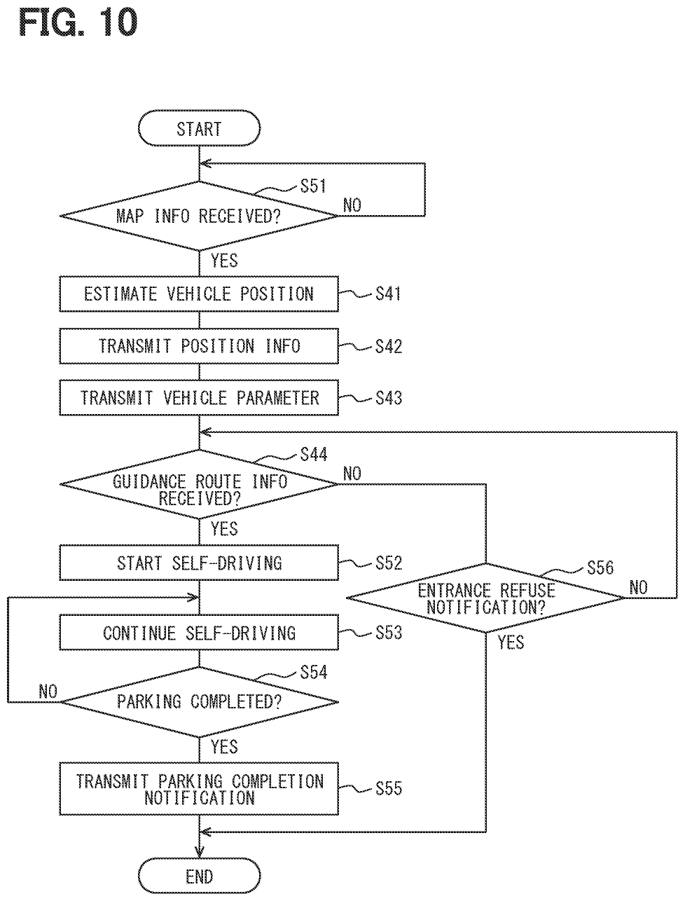

For example, as shown in FIG. 9, on the road surface of the parking lot, multiple markers may be prepared arranged at an interval of predetermined unit length. The unit length may be set to be shorter than the width and the length of the self-driving vehicle 18. The position setting unit 47B may set the markers corresponding to the size of self-driving vehicle 18. In the example shown in FIG. 9, multiple markers are prepared and each marker has a different symbol from the adjacent marker. The multiple markers are arranged every 1.0 meter in the length direction of the vehicle and are also arranged every 0.5 meters in the width direction of the vehicle.

The position setting unit 47B designates, corresponding to the classification result of the self-driving vehicle 18, four markers that define four corners corresponding to the self-driving vehicle 18 in order to position four corners of the self-driving vehicle 18 on the designated four markers. For example, when the self-driving vehicle 18 is an ordinary passenger car, four markers are designated so that an area having a width of 2.0 meters and a length of 5.0 meters is defined by the four markers. When the self-driving vehicle 18 is a light vehicle, four markers are designated so that an area having a width of 1.5 meters and a length of 4.0 meters is defined by the four markers.

The self-driving vehicle 18 searches for the designated markers by a sensor such as a camera mounted on the own vehicle, and recognizes the parking position based on the four markers.

According to such a configuration, since the parking position is defined by the designated markers corresponding to the classification result of the self-driving vehicle 18, the self-driving vehicle 18 can be accurately parked in the parking position by recognizing the parking position based on the markers.

(2b) In the above-described aspect (2a), the position setting unit 47B sets the parking positions so that the self-driving vehicles 18 included in the same classification group are arranged adjacent to one another. For example, when the close area 7A corresponding to the classification result is full, the position setting unit 47B may use, as the close area 7A, one line of the medium area 7B closest to the close area 7A.

With this configuration, it is possible to dynamically set the sections of various sizes, thereby improving utilization efficiency of parking sections in the parking lot.

(2c) In the above-described aspects (2a) and (2b), different symbols are used as the markers. Alternatively, same symbols or different symbols may be used as the markers as necessary. For example, as the marker, an object can be recognized from the vehicle, such as a painting on the road surface, a reflecting plate may be adopted.

(2d-1) In the above embodiments, after the self-driving vehicle 18 transmits the position information, the vehicle parameters are transmitted from the self-driving vehicle 18 to determine whether the vehicle is allowed to enter the parking area for parking purpose. The present disclosure is not limited to this configuration. Alternatively, before the self-driving vehicle 18 enters the entrance room 3, information related to vehicle type may be transmitted to the management device 39 to determine whether the vehicle is allowed to enter the parking lot for parking purpose.

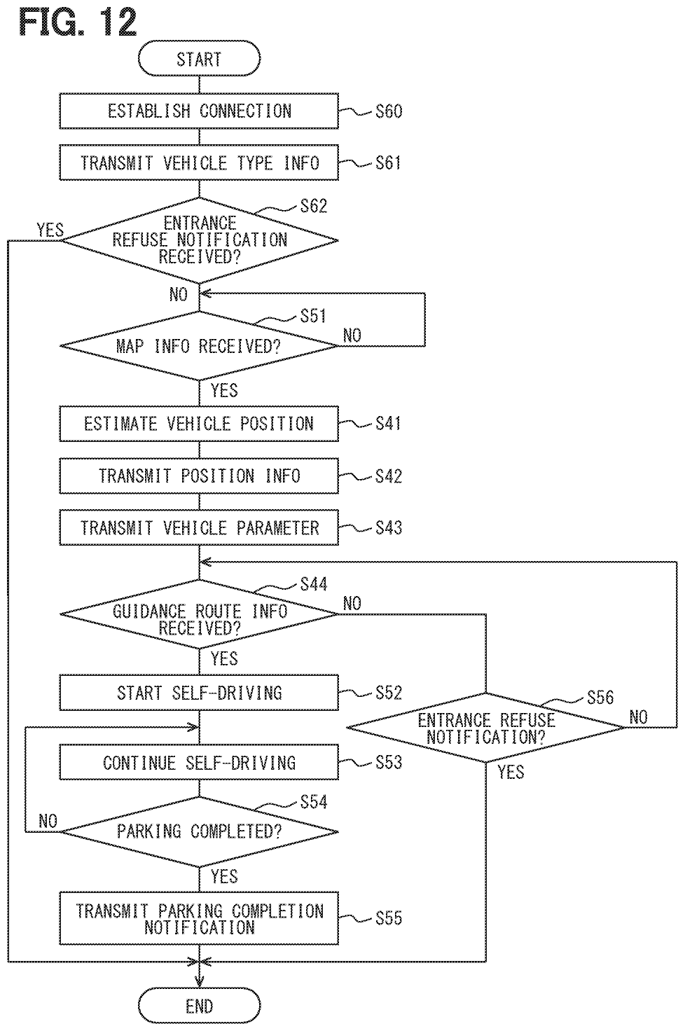

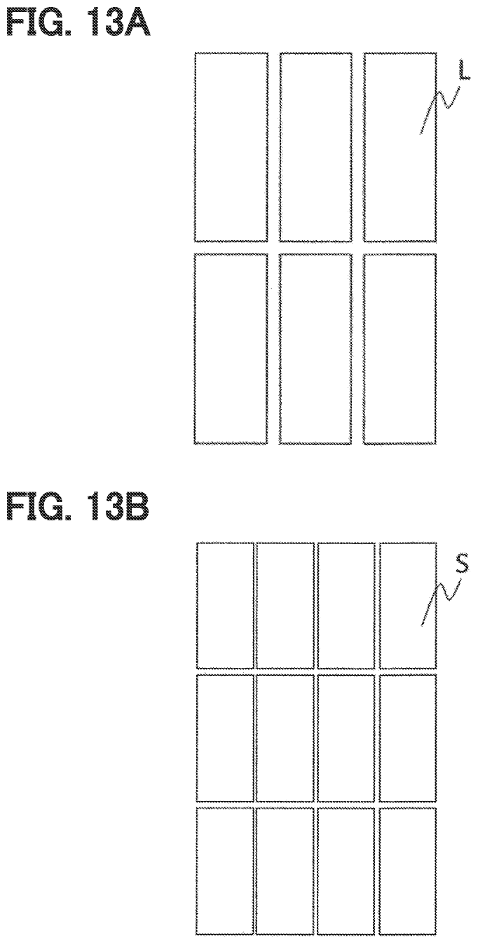

For example, information of vehicle type (also referred to as vehicle type information) may be transmitted as the information related to the vehicle type. The vehicle type refers to a vehicle type such as a light vehicle, an ordinary vehicle, a medium-size vehicle, a large vehicle, and the like. The following will describe a modification example of the parking setting process with reference to FIG. 11 and FIG. 12.

In the above embodiment, although the detailed description is omitted, when the self-driving vehicle 18 approaches or enters the parking lot, the self-driving vehicle 18 establishes, with the management device 39, a connection and become in a communicable state. The time at which the self-driving vehicle 18 establishes the connection with the management device 39 may be set in different manner. For example, the time at which the self-driving vehicle 18 establishes the connection with the management device 39 may be set at a time when the self-driving vehicle 18 approaches the entrance 15 from the outside of the parking lot, a time when the self-driving vehicle 18 passes through the entrance 15, or a time when the self-driving vehicle 18 is entering the entrance room 3 after passing through the entrance 15. For example, the communication connection may be repeatedly tried from a certain time point until the connection is surely established.

FIG. 11 shows a parking setting process indicating the above-described configuration. The parking setting process is executed by the management device 39. The management device 39 repeatedly attempts to establish the connection in S30 until the connection is established in S30. In S30, when the management device 39 establishes the connection with the self-driving vehicle 18, the management device 39 switches to the communicable state with the self-driving vehicle.

In S31, the classification unit 47A of the management device 39 determines whether the vehicle type information is received from the self-driving vehicle 18. When the classification unit 47A has not received the vehicle type information in S31, the classification unit 47A repeats S31.

In response to receiving the vehicle type information, the classification unit 47A proceeds to S32. The classification unit 47A determines whether the self-driving vehicle 18 can be parked in the parking area based on the vehicle type information transmitted from the self-driving vehicle 18. That is, based on the vehicle type information, the classification unit determines whether the self-driving vehicle 18 is within the preset standard. For example, in a case where the vehicle type of the self-driving vehicle 18 indicates a large vehicle and the empty parking sections in the parking lot are only available for light vehicles and ordinary vehicles, the classification unit 47A determines that the vehicle does not conform to the preset standard and determines that parking lot is unavailable.

When the self-driving vehicle 18 is determined to be not conform to the preset standard, the process proceeds to S18. In S18, the driving setting unit 47C refuses the self-driving vehicle 18 to enter the parking area, and ends the parking setting process. The driving setting unit 47C notifies the self-driving vehicle 18 of the entrance refusal, which indicates the entrance refusal to the parking area.

When the vehicle type of the self-driving vehicle 18 conforms to the standard, an entrance allowance is notified to the self-driving vehicle 18, and the process proceeds to S21. The process executed in S21, S22, S23, S24, and S25 are the same as those in the above embodiments.

The following will describe the automatic parking process with reference to FIG. 12. The automatic parking process shown in FIG. 12 is a process in which the self-driving vehicle 18 automatically moves to the parking position from a time at which the connection with the management device 39 is established corresponding to the parking setting process executed by the management device 39.

The self-driving vehicle 18 repeatedly attempts to establish connection with the management device in S60 until the connection is established in S60. In S60, when the self-driving vehicle 18 establishes the connection with the management device 39, the self-driving vehicle 18 switches to a communicable state with the management device 39. In S61, the information transmission unit 69A of the controller 69 transmits vehicle type information.

In S62, the self-driving vehicle determines whether the management device 39 has notified the entrance refusal, which is a notification indicating the entrance refusal to the parking area. In a case where no entrance refusal is notified, the process proceeds to S51. In the case where no entrance refusal is notified, as a response to the vehicle type information transmitted from the self-driving vehicle 18, the self-driving vehicle 18 receives a notification that indicates the vehicle type of the self-driving vehicle 18 conforms to the preset standard.

When determining that the entrance refusal is received in S62, the automatic parking process is ended. Alternatively, the user may be notified via the self-driving vehicle 18 that the entrance to the parking lot is refused. The process executed after S51 is the same as above embodiments, and detailed description will be omitted.

(2d-2) According to the above-described aspect (2d-1), the same effect as that of the above embodiments can be obtained. With this configuration, it is possible to prevent vehicles without automatic parking function from entering the entrance room, and the utilization efficiency of the parking lot can be improved. In addition, for users of vehicles without valet parking function, that is, automatic parking function, it is possible to be notified of vehicles without automatic parking function cannot be parked in the parking lot before the vehicle enters the entrance room, thereby improving user convenience. For other users of the vehicles with valet parking function, convenience is also improved because more parking sections are available.

(2e) The close area 7A is divided into multiple sections so that only vehicles with small sizes can be parked. The medium area 7B and the far area 7C are divided into multiple sections so that vehicles having sizes larger than the small vehicles can be parked. The present disclosure is not limited to this configuration.

For example, as multiple parking areas 7 of the parking lot, the medium area 7B may be omitted, and only the close area 7A and the far area 7C may be set in the parking lot. In this configuration, for example, the close area 7A and the far area 7C may be set as follows.

In the parking lot, an area close to the entrance room 3 and the exit room 5 may be set as the close area 7A, and an area far from the entrance room 3 and the exit room 5 may be set as the far area 7C. The close area 7A may be mainly provided to large-size vehicles for parking purpose, and the far area 7C may be provided to only small-size vehicles for parking purpose. The boundary of the close area 7A that is close to the entrance room 3 and the exit room 5 may be based on an intermediate point (for example, a position located at a center of gravity) of the parking area 7. Alternatively, the types of vehicles using the parking lot may be investigated, and the range of close area may be properly set according to the survey result.

In a configuration where the parking areas are set as described above, the self-driving vehicles 18 are classified according to the vehicle parameters. Thus, it is possible to collectively park multiple self-driving vehicles 18 that require parking sections of similar sizes close to one another. Thus, the parking sections can be used in efficient manner. In a case where the close area is mainly provided to the large-size vehicles, the large-size vehicles moves along the paths only in the close area 7A that is close to the entrance room 3 and the exit room 5. Therefore, the paths from the entrance room 3 and the exit room 5 to the close area 7A and the paths in the close area 7A are set to have a large width, and paths included in the far area 7C may be set to small widths, that is, narrow paths. Thus, it is possible to increase the area that can be set as the parking sections in the parking area 7.

(2f) As described above, a direction in which multiple parking sections are aligned along the entrance room 3 or the exit room 5 is referred to as the row direction, and a direction perpendicular to the row direction is referred to as the column direction. Along the row direction, the rightmost two rows of sections viewed from the entrance room 3 and the exit room 5 may be set as a first area 7D. Then, along the row direction, the leftmost one row of sections viewed from the entrance room 3 and the exit room 5 may be set as a third area 7F. The parking area of the parking lot excluding the first area 7D and the third area 7F may be set as a second area 7E.

When the direction in which multiple parking sections in the entrance room 3 and the exit room 5 are aligned is referred to as the row direction, the vehicle width direction along which multiple self-driving vehicles 18 are parked are in the parking area 7 may be set to be substantially parallel to one another. Alternatively, the row direction may be set different from the vehicle width direction except parallel relationship.

According to this configuration also, the end positions of multiple vehicles can be aligned when the self-driving vehicles 18 are parked in the corresponding parking positions, thereby improving the utilization efficiency of the parking area.

(2g) In one aspect of the present disclosure, the classification unit 47A receives information related to the type of the self-driving vehicle 18 before the self-driving vehicle 18 arrives at the alighting area, and determines, based on the received vehicle type information, whether the self-driving vehicle 18 is within the preset standard. The driving setting unit 47C may notify the self-driving vehicle 18 of the entrance refusal when the self-driving vehicle 18 is out of the preset standard.

According to this configuration, before the vehicle arrives at the alighting area, whether the self-driving vehicle is within the preset standard is determined. When determining that the self-driving vehicle 18 is not within the preset standard, the self-driving vehicle 18 can be notified of the entrance refusal. For example, when the vehicle type is used as the preset standard, it is possible to notify the entrance refusal to the user at an earlier time in response to the entrance refusal being determined according to the vehicle type.

(2h) The multiple functions of one component in the above embodiments may be implemented by multiple components, or a function of one component may be implemented by multiple components. Further, multiple functions of multiple components may be implemented by one component, or one function implemented by multiple components may be implemented by one component. In addition, a part of the configuration of the above embodiment may be omitted. Further, at least part of the configuration of the above-described embodiment may be added to or replaced with the configuration of another embodiment described above.

(2i) In addition to the management device 39 described above, the present disclosure may be implemented in various forms, such as the parking assistance system 1 including the management device 39, a program to implement a computer as the management device 39 or the self-driving vehicle 18, a non-transitory tangible storage medium such as a semiconductor memory storing the program, and a parking assist method. In the parking assistance system 1, the parking lot may be included as a component.

What is claimed is:

1. A parking assistance apparatus that assists a parking of a vehicle, the parking assistance apparatus comprising:
a classification unit classifying a self-driving vehicle according to a vehicle parameter including a value indicating a size of region required for the self-driving vehicle to travel through, the self-driving vehicle performing a self-driving from an alighting area of a parking lot to a target parking position located in a parking area that includes multiple parking positions;
a position setting unit setting the target parking position of the self-driving vehicle so that the parking positions including the target parking position are set in collective manner in the parking area according to a classification result of the self-driving vehicle; and
a driving setting unit setting a guidance route that guides the self-driving vehicle to the target parking position,
wherein
the classification unit adopts, as the vehicle parameter, a detection range of a sensor that detects a surrounding of the self-driving vehicle, and
the classification unit classifies the self-driving vehicle according to the detection range of the sensor.

2. The parking assistance apparatus according to claim 1, wherein
the classification unit adopts, as the vehicle parameter, a size of the self-driving vehicle, and
the classification unit classifies the self-driving vehicle according to the size of the self-driving vehicle.

3. The parking assistance apparatus according to claim 2, wherein
the position setting unit sets the target parking position of the self-driving vehicle classified into a first size closer to a boarding and alighting position where an occupant gets on or off the self-driving vehicle compared with the target parking position of the self-driving vehicle classified into a second size, and
the first size is set to be smaller than the second size.

4. The parking assistance apparatus according to claim 1, wherein
the classification unit adopts, as the vehicle parameter, a maximum turning angle of wheels of the self-driving vehicle or a minimum turning circle of the self-driving vehicle, and
the classification unit classifies the self-driving vehicle according to the maximum turning angle or the minimum turning circle.

5. The parking assistance apparatus according to claim 1, wherein
a road surface of the parking lot includes multiple markers prepared in advance so that the multiple markers are recognized by the self-driving vehicle, and
the position setting unit sets the target parking position by designating, among the multiple markers, specific markers corresponding to the classification result of the self-driving vehicle so that the specific markers define end portions of the target parking position.

6. The parking assistance apparatus according to claim 1, wherein
the classification unit determines, based on the vehicle parameter of the self-driving vehicle, whether the self-driving vehicle is within a preset standard, and
the driving setting unit notifies the self-driving vehicle of an entrance refusal in response to the self-driving vehicle being determined to be out of the preset standard.

7. A parking assistance system comprising:
a parking assistance apparatus assisting a vehicle parking; and
a parking lot including an alighting area and a parking area, the parking area including multiple parking positions,
wherein
the parking assistance apparatus includes:
a classification unit classifying a self-driving vehicle according to a vehicle parameter indicating a value related to the self-driving vehicle, the self-driving vehicle performing a self-driving from the alighting area to a target parking position located in the parking area,
a position setting unit setting the target parking position of the self-driving vehicle so that the parking positions including the target parking position are set in collective manner in the parking area according to a classification result of the self-driving vehicle; and
a driving setting unit setting a guidance route that guides the self-driving vehicle to the target parking position,
wherein
the classification unit adopts, as the vehicle parameter, a detection range of a sensor that detects a surrounding of the self-driving vehicle, and
the classification unit classifies the self-driving vehicle according to the detection range of the sensor.

8. The parking assistance system according to claim 7, wherein
a road surface of the parking lot includes multiple markers prepared in advance so that the multiple markers are recognized by the self-driving vehicle, and
the position setting unit sets the target parking position by designating, among the multiple markers, specific markers corresponding to the classification result of the self-driving vehicle so that the specific markers define end portions of the target parking position.

9. The parking assistance system according to claim 7, wherein
the classification unit adopts, as the vehicle parameter, a size of the self-driving vehicle,
the classification unit classifies the self-driving vehicle according to the size of the self-driving vehicle, and
the position setting unit sets the target parking position of the self-driving vehicle classified into a size smaller than a predetermined threshold closer to a boarding and alighting position where an occupant gets on or off the self-driving vehicle compared with the target parking position of the self-driving vehicle classified into a size equal to or greater than the predetermined threshold.

10. The parking assistance system according to claim 7, further comprising
a parking area management unit setting the parking area of the parking lot corresponding to the classification result of the self-driving vehicle, and
the position setting unit sets the target parking position in the parking area that is set corresponding to the classification result of the self-driving vehicle.

11. The parking assistance system according to claim 10, wherein,
in response to determining that a vacant parking position is not available in the parking area corresponding to the classification result of the self-driving vehicle, the parking area management unit changes the parking area corresponding to the classification result to an adjacent area, and sets the adjacent area as the parking area corresponding to the classification result.

12. The parking assistance system according to claim 10, wherein,
the classification unit receives information related to a type of the self-driving vehicle before the self-driving vehicle arrives at the alighting area, and determines, based on the received information related to the type of the self-driving vehicle, whether the self-driving vehicle is within a preset standard, and
the driving setting unit notifies the self-driving vehicle of an entrance refusal in response to the self-driving vehicle being determined to be out of the preset standard.

13. The parking assistance system according to claim 7, wherein,
the classification unit adopts, as the vehicle parameter, a size of the self-driving vehicle,
the classification unit classifies the self-driving vehicle according to the size of the self-driving vehicle, and
the position setting unit sets the target parking position of each self-driving vehicle so that the self-driving vehicles classified into the same size are aligned in a vehicle width direction when the self-driving vehicles are parked.

14. A parking assistance apparatus that assists a parking of a vehicle, the parking assistance apparatus comprising:
a computer-readable non-transitory storage medium; and
a microcomputer, by executing a program stored in the computer-readable non-transitory storage, configured to:
classify a self-driving vehicle according to a vehicle parameter including a value indicating a size of region required for the self-driving vehicle to travel through, the self-driving vehicle performing a self-driving from an alighting area of a parking lot to a target parking position located in a parking area that includes multiple parking positions;
set the target parking position of the self-driving vehicle so that the parking positions including the target parking position are set in collective manner in the parking area according to a classification result of the self-driving vehicle; and
set a guidance route that guides the self-driving vehicle to the target parking position,
wherein the microcomputer sets, as the vehicle parameter, a detection range of a sensor that detects a surrounding of the self-driving vehicle, and classifies the self-driving vehicle according to the detection range of the sensor.
